(19) United States
(12) Patent Application Publication
(10) Pub. No.: US 2024/0347868 A1
(43) Pub. Date: Oct. 17, 2024

(54) BUS BAR MODULE

(71) Applicant: YAZAKI CORPORATION, Tokyo (JP)

(72) Inventors: Tatsuya OGA, Shizuoka (JP); Hirokuni KOIKE, Shizuoka (JP); Yoshiki AOSHIMA, Shizuoka (JP); Kimitoshi MAKINO, Shizuoka (JP)

(73) Assignee: YAZAKI CORPORATION, Tokyo (JP)

(21) Appl. No.: 18/630,055

(22) Filed: Apr. 9, 2024

(51) Int. Cl. H01M 50/503; H01M 50/521

(52) U.S. Cl. CPC H01M 50/503; H01M 50/521

(57) ABSTRACT

The bus bar module includes a circuit body composed of a flexible substrate provided with a circuit wiring. The circuit body includes a belt-shaped main body extending along a predetermined direction and a plurality of bus bar portions arranged at a distance in an extending direction of the main body. At least a part of the bus bar portions is arranged to overlap with the main body.

### CROSS-REFERENCE TO RELATED APPLICATIONS

The present application is based on, and claims priority from the prior Japanese Patent Application No. 2023-067045, filed on Apr. 17, 2023, the entire contents of which are incorporated herein by reference.

### TECHNICAL FIELD

The present disclosure relates to a bus bar module.

### BACKGROUND

The bus bar module is, for example, attached to a battery module (a battery pack in which single cells are stacked) as a driving power source mounted on an electric vehicle, a hybrid vehicle, and the like. (See JP 2020-205175 A).

Generally, the single cells constituting the battery pack expand and contract in a stacking direction of the single cells due to the heat caused during operation of charging and discharging, the temperature of the external environment and the like. As a result, the battery pack (battery module) also deforms to expand and contract in the stacking direction of the single cells. In addition, due to the assembly tolerance generated during stacking single cells, generally, the size of the battery pack in the stacking direction may vary for each manufactured battery pack due to manufacturing variations. Therefore, generally, the bus bar module is designed with a certain margin in the length of a bus bar branch strip (bus bar) connected to each single cell in order to handle such positional variations due to deformation of the battery pack, manufacturing variations and the like.

### SUMMARY OF THE INVENTION

In JP 2020-205175 A, it is a problem that positional variations of the battery pack are absorbed by folding the bus bar branch strip connected to each single cell into an S-shape in the vertical direction, which makes it difficult to reduce the height of the bus bar module due to the absorption structure using the height.

The present disclosure has been made in view of such a problem of the background art. An object of the present disclosure is to provide a bus bar module capable of absorbing positional variations of a counterpart connection device while reducing the height of the bus bar module.

The bus bar module according to an aspect of the present disclosure includes a circuit body composed of a flexible substrate provided with a circuit wiring, and the circuit body has a belt-shaped main body extending in a predetermined direction and a plurality of bus bar portions arranged at a distance in an extending direction of the main body, and at least a part of the bus bar portions is arranged to overlap with the main body.

According to the present disclosure, it is possible to provide a bus bar module capable of absorbing positional variations of a counterpart connection device while reducing the height of the bus bar module.

### BRIEF DESCRIPTION OF DRAWINGS

FIG. 1 is a plan view illustrating an example of a bus bar module according to the first embodiment.

FIG. 2 is an enlarged plan view of a bus bar portion of a bus bar module.

FIG. 3 is an enlarged perspective view of a main part illustrating a state in which a bus bar portion is folded at the folding portion.

FIG. 4 is an enlarged plan view of a main part illustrating a state in which a bus bar portion is folded at the folding portion.

FIG. 5 is a plan view illustrating an example of a bus bar module according to the second embodiment.

FIG. 6 is a perspective view of a bus bar portion formed separately from the main body.

FIG. 7 is a perspective view illustrating a state in which the bus bar portion is connected to the main body.

FIG. 8 is an enlarged plan view of the main part of the bus bar module.

### DETAILED DESCRIPTION OF THE INVENTION

Hereinafter, the bus bar module according to the present embodiment will be described in detail with reference to the drawings. It is noted that the dimensional ratio of the drawings is exaggerated for the sake of explanation and may differ from the actual ratio.

### First Embodiment

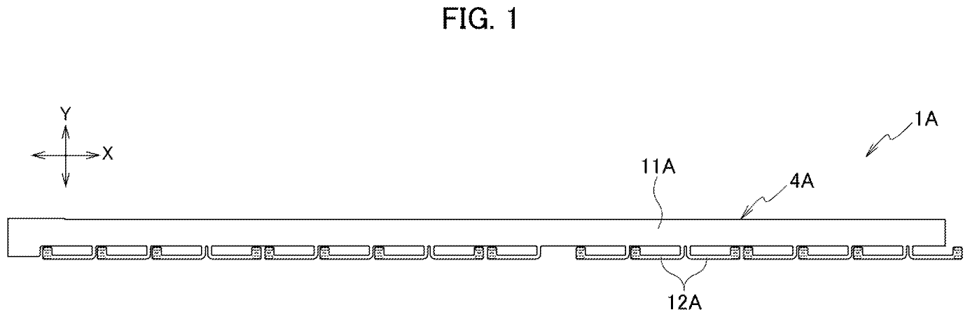

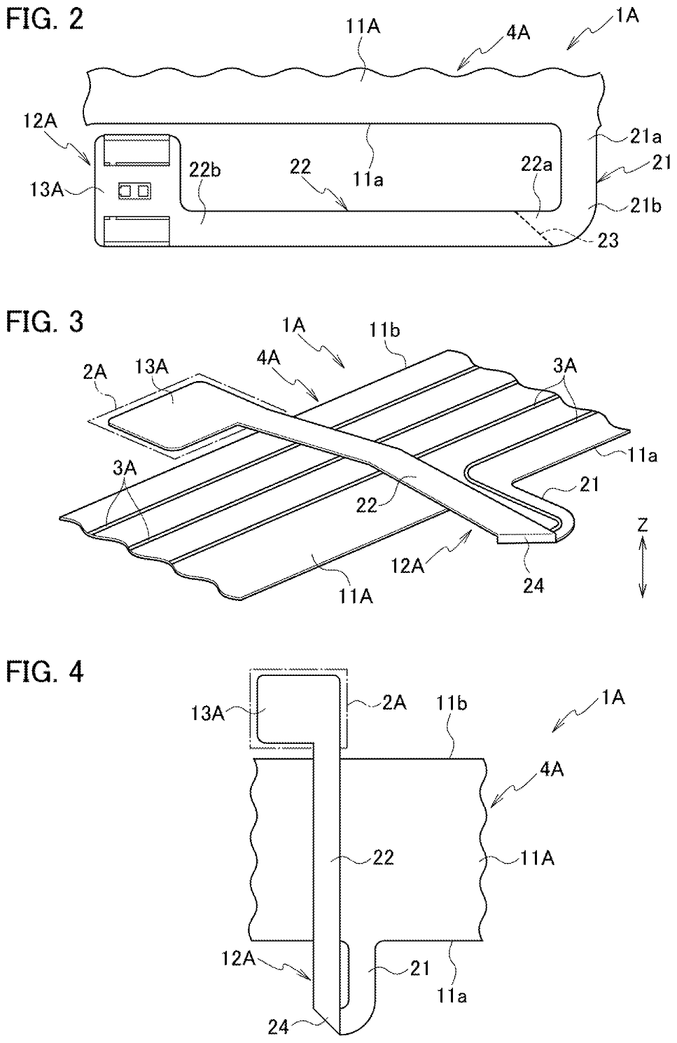

FIG. 1 is a plan view illustrating an example of a bus bar module 1A according to the first embodiment, and FIG. 2 is an enlarged plan view of a bus bar portion 12A of the bus bar module 1A. FIG. 3 is an enlarged perspective view of a main part illustrating a state in which the bus bar portion 12A is folded at the folding portion 24, and FIG. 4 is an enlarged plan view of the main part illustrating a state in which the bus bar portion 12A is folded at the folding portion 24.

First, a battery pack (battery module) will be described as an example of a counterpart device to which the bus bar module 1A according to the first embodiment is attached. The battery pack is composed of, for example, a plurality of single cells (battery cells) connected in series. Each of these single cells has a cell body formed in a cuboid, and provided with a terminal portion 2A (see FIGS. 3 and 4) such as a positive electrode and negative electrode on an upper surface (electrode surface) of the cell body.

As illustrated in FIGS. 1 to 4, the bus bar module 1A is composed of a flexible substrate provided with a circuit wiring (wiring 3A), and includes a circuit body 4A provided with a bus bar (bus bar portion 12A) connected to the terminal portion 2A of the single cell.

The circuit body 4A has a belt-shaped main body 11A extending along a direction in which the single cells are aligned (a stacking direction of the single cells), and a plurality of bus bar portions 12A arranged at a distance in an extending direction X of the main body 11A.

A bus bar portion 12A includes a first extending portion 21 and a second extending portion 22 extending from the main body 11A in an arm-like shape.

The first extending portion 21 extends from one end 11a side in the width direction Y of the main body 11A and extends along the width direction Y of the main body 11A in a direction away from the main body 11A. That is, a base end 21a of the first extending portion 21 is connected to one end 11a in the width direction Y of the main body 11A, and the tip end 21b of the first extending portion 21 is connected to a base end 22a of the second extending portion 22 (see FIG. 2).

On the other hand, the second extending portion 22 is arranged to overlap with the main body 11A in a height direction Z of the main body 11A. Specifically, the second extending portion 22 is arranged to straddle the main body 11A in a direction intersecting (in the illustrated example, perpendicular to) the extending direction X of the main body 11A. Therefore, the second extending portion 22 extends along the width direction Y of the main body 11A to straddle from one end 11a side to the other end 11b side in the width direction Y of the main body 11A. That is, the base end 22a of the second extending portion 22 is connected to the tip end 21b of the first extending portion 21, and a tip end 22b of the second extending portion 22 is connected to a connection portion 13A (see FIG. 2).

The connection portion 13A is connected to the terminal portion 2A of the single cell, which is arranged on the other end 11b side in the width direction Y of the main body 11A (see FIGS. 3 and 4).

Although not illustrated in FIG. 2, on a surface (upper surface) of the circuit body 4A illustrated in FIG. 2, a wiring 3A, such as a voltage detection line in a predetermined pattern, is provided. For example, the second extending portion 22 of a bus bar portion 12A is bent (folded) at a portion indicated by a dashed line 23 in FIG. 2. As illustrated in FIGS. 3 and 4, in a state in which the second extending portion 22 of the bus bar portion 12A is bent, the connection portion 13A of the bus bar portion 12A is electrically connected to the terminal portion 2A of the single cell by use of soldering and the like.

As illustrated in FIGS. 3 and 4, in a state in which the connection portion 13A of a bus bar portion 12A is connected to the terminal portion 2A of the single cell, a folding portion 24 is formed between the first extending portion 21 and the second extending portion 22 and folded in a direction toward the main body 11A from a direction away from the main body 11A.

The length of the second extending portion 22 from the folding portion 24 to the connection portion 13A is set to be longer than the width of the main body 11A. Therefore, in a state in which the connection portion 13A of the bus bar portion 12A is connected to the terminal portion 2A of the single cell, the second extending portion 22 has an arch shape (curved shape) that is convex upward in the extension direction X of the main body 11A.

In a state in which the connection portion 13A of a bus bar portion 12A illustrated in FIGS. 3 and 4 is connected to the terminal portion 2A of the single cell, the first extending portion 21 and second extending portion 22 in an arm-like shape extending from the main body 11A can be deformed (displaced) from an initial state. Therefore, the direction of the positional variations of the single cells to be absorbed in the bus bar portion 12A is not limited, and the positional variations of the single cells in all directions (extension direction X, width direction Y, and height direction Z of the main body 11A) can be absorbed.

Further, by connecting the connection portion 13A to the terminal portion 2A of the single cell in a state in which the second extending portion 22 of the bus bar portion 12A is folded, the positional variations of the single cells can be absorbed without using the height as an absorbing structure. In particular, the height of the bus bar module 1A can be suppressed in comparison with a conventional bus bar branch strip (bus bar) folded in an S-shape in the vertical direction. By suppressing an increase in the height of the bus bar module 1A and reducing the height of the bus bar module 1A, it is possible to arrange the bus bar module 1A in a narrow space.

In this embodiment, the main body 11A and the bus bar portion 12A of the bus bar module 1A are integrally formed on a flexible substrate, so that the yield of the flexible substrate can be improved and the manufacturing cost of the bus bar module 1A can be reduced.

Furthermore, the entire bus bar module 1A can be composed of a single-sided flexible substrate (single-sided substrate). Therefore, the manufacturing cost of the bus bar module 1A can be reduced compared with the case that the entire bus bar module 1A is composed of a double-sided flexible substrate (double-sided substrate).

Next, the effects of the bus bar module 1A will be described.

As described above, the bus bar module 1A according to the first embodiment includes a circuit body 4A composed of a flexible substrate provided with a circuit wiring (wiring 3A). The circuit body 4A includes a belt-shaped main body 11A extending along a predetermined direction and a plurality of bus bar portions 12A arranged at a distance in an extending direction X of the main body 11A. At least a part (second extending portion 22) of the bus bar portions 12A is arranged to overlap with the main body 11A.

In the bus bar module 1A, the positional variations of the single cells can be absorbed by the deformation of the second extending portion 22 arranged to overlap with the main body 11A, and an increase in the height of the bus bar module 1A can be suppressed compared with a case that a bus bar portion 12A is folded in a S-shape in the vertical direction. Therefore, by reducing the height of the bus bar module 1A, it is possible to arrange the bus bar module 1A in a narrow space.

As described above, according to the first embodiment, while reducing the height of the bus bar module 1A, it is possible to provide the bus bar module 1A capable of absorbing positional variations of a counterpart connection device (single cell).

In the bus bar module 1A according to the first embodiment, a part of the bus bar portions 12A (second extending portion 22) may be arranged to straddle the main body 11A in a direction intersecting the extending direction X of the main body 11A.

By arranging the second extending portion 22 of a bus bar portion 12A in this manner, it is possible to absorb the positional variations of the single cells in a direction intersecting (in the illustrated example, perpendicular to) the direction in which the single cells are aligned (the stacking direction).

The bus bar portion 12A may have a first extending portion 21 extending from one end side in a width direction of the main body 11A and extending in a direction away from the main body 11A, and a folding portion 24 connected to the first extending portion 21 and folded in a direction toward the main body 11A from a direction away from the main body 11A. The bus bar portion 12A may have a second extending portion 22 connected to the folding portion 24 and extending to straddle from one end 11a side to the other end 11b side in the width direction Y of the main body 11A. The bus bar portion 12A may have a connection portion 13A connected to the second extending portion 22 and connected to a terminal portion 2A of a single cell arranged on the other end 11b side in the width direction Y of the main body 11A.

The second extending portion 22 of the bus bar portion 12A straddles the main body 11A, so that the length in the direction of absorbing the positional variations of the single cells can be secured by the length of the second extending portion 22, and a long distance can be secured to be able to absorb the positional variations in the alignment direction of single cells. Further, the position of the folding portion 24 (see dashed line 23 in FIG. 2) is set as appropriate, so that the distance in which the positional variations can be absorbed in the alignment direction of single cells can be adjusted.

### Second Embodiment

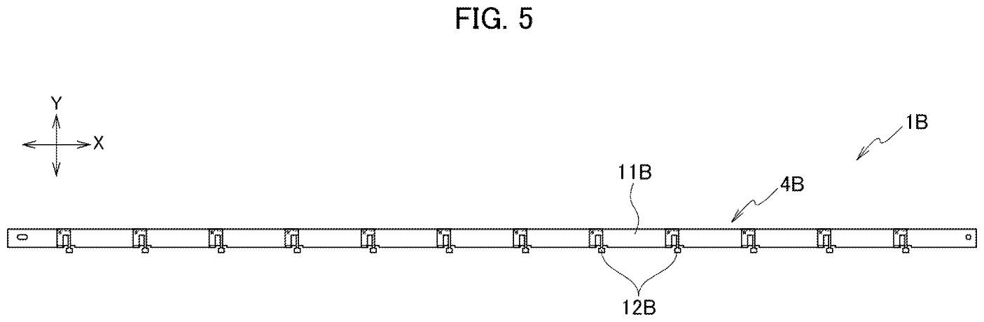

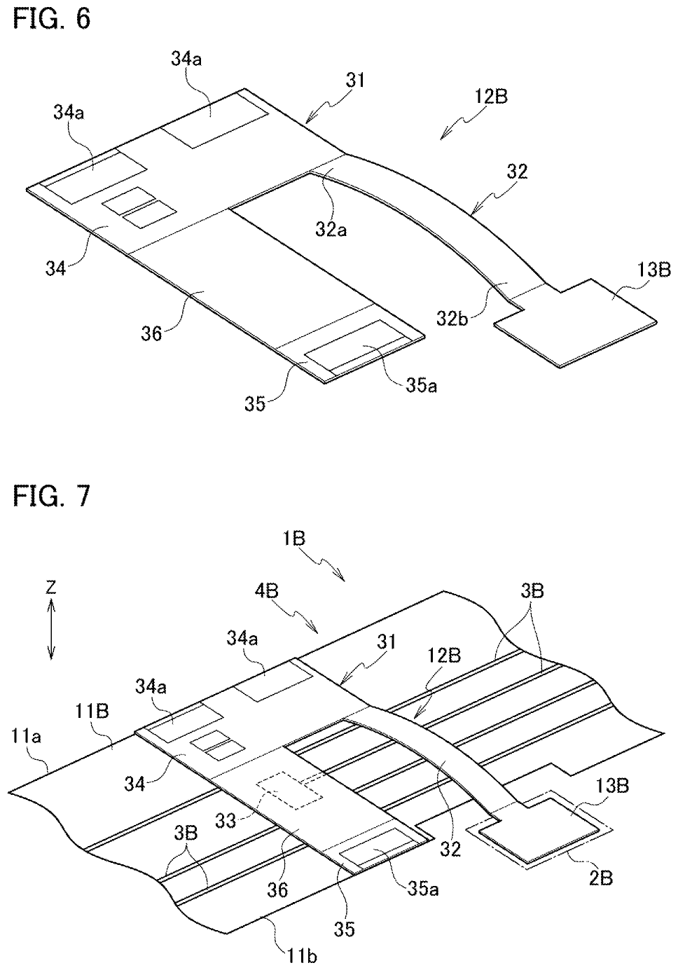

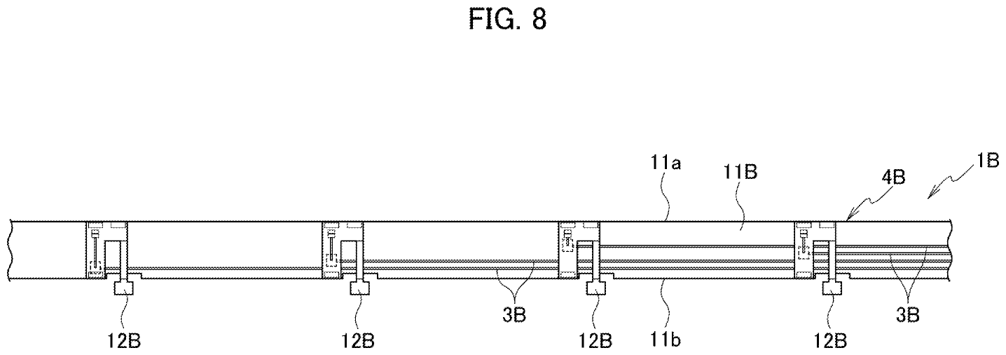

FIG. 5 is a plan view illustrating an example of the bus bar module 1B according to the second embodiment, and FIG. 6 is a perspective view of a bus bar portion 12B formed separately from the main body 11B. FIG. 7 is a perspective view illustrating a state in which the bus bar portion 12B is connected to the main body 11B, and FIG. 8 is an enlarged plan view of the main portion of the bus bar module 1B.

First, a battery pack (battery module) will be described as an example of a counterpart device to which the bus bar module 1B according to the second embodiment is attached. The battery pack is composed of, for example, a plurality of single cells (battery cells) connected in series. Each of these single cells has a cell body formed in a cuboid, and provided with a terminal portion 2B (see FIG. 7) such as a positive electrode and a negative electrode on an upper surface (electrode surface) of the cell body.

As illustrated in FIGS. 5 to 8, the bus bar module 1B is composed of a flexible substrate provided with a circuit wiring (wiring 3B), and includes a circuit body 4B provided with a bus bar (bus bar portion 12B) connected to the terminal portion 2B of the single cell.

The circuit body 4B has a belt-shaped main body 11B extending along the direction in which the single cells are aligned (a stacking direction of the single cells), and a plurality of bus bar portions 12B arranged at a distance in the extension direction X of the main body 11B.

The bus bar portions 12B are formed separately from the main body 11B, and thereafter electrically connected to the main body 11B by soldering and the like. The bus bar portions 12B are overlapped on the main body 11B and is connected to the main body 11B by soldering and the like through the bonding portions 34a, 35a (see FIG. 7).

Further, the bus bar portions 12B include a circuit divider 31 and an arm-shaped extending portion 32 extending from the circuit divider 31.

The circuit divider 31 is electrically connected to the main body 11B by soldering and the like through an electrical connection portion 33 (see FIG. 7). The circuit divider 31 has a first bonding portion 34 connected to an end portion of one end 11a side in a width direction Y of the main body 11B, a second bonding portion 35 connected to an end portion of the other end 11b side in the width direction Y of the main body 11B, and a pad 36 disposed between the first bonding portion 34 and the second bonding portion 35. In this embodiment, the length of the first bonding portion 34 in a extending direction X of the main body 11B is longer than the length of the second bonding portion 35 in the extending direction X of the main body 11B, and the circuit divider 31 is formed in a substantially L-shape viewed in a height direction Z of the main body 11B.

On the other hand, the extending portion 32 is arranged to overlap with the main body 11B in the height direction Z of the main body 11B. Specifically, the extending portion 32 is arranged to straddle the main body 11B in a direction intersecting (in the illustrated example, perpendicular to) the extending direction X of the main body 11B. Therefore, the extending portion 32 extends along the width direction Y of the main body 11B to straddle from one end 11a side to the other end 11b side in the width direction Y of the main body 11B. That is, the base end 32a of the extending portion 32 is connected to one end portion (first bonding portion 34) of the circuit divider 31, and the tip end 32b of the extending portion 32 is connected to the connection portion 13B (see FIG. 6).

The connection portion 13B is connected to the terminal portion 2B of the single cell, which is arranged on the other end 11b side in the width direction Y of the main body 11B (see FIG. 7).

On a front surface (upper surface) of the main body 11B illustrated in FIG. 7, a wiring 3B such as a voltage detection line in a predetermined pattern is provided, and on a rear surface (lower surface) of a bus bar portion 12B, a wiring on the side of the bus bar portion 12B is provided. The wiring 3B on the side of the main body 11B and the wiring on the side of the bus bar portion 12B are connected by soldering and the like through the aforementioned electrical connection portion 33. As illustrated in FIG. 7, in a state in which the bus bar portion 12B is mounted on the main body 11B, the connection portion 13B of the bus bar portion 12B is electrically connected to the terminal portion 2B of the single cell by soldering and the like.

As illustrated in FIG. 7, in a state in which the connection portion 13B of the bus bar portion 12B is connected to the terminal portion 2B of the single cell, the extending portion 32 is arranged to overlap with the main body 11B and the main body 11B in the height direction Z of the main body 11B. Further, in a state in which the connection portion 13B of the bus bar portion 12B is connected to the terminal portion 2B of the single cell, the extending portion 32 has an arch shape (curved shape) which is convex upward in the extending direction X of the main body 11B.

In a state in which the connection portion 13B of the bus bar portion 12B illustrated in FIG. 7 is connected to the terminal portion 2B of the single cell, the arm-shaped extending portion 32 extending from the circuit divider 31 can be deformed (displaced) from an initial state. Therefore, the direction of the positional variations of the single cells absorbed in the bus bar portion 12B is not limited, and the positional variations of the single cells in all directions (extension direction X, width direction Y, and height direction Z of the main body 11B) can be absorbed.

Further, by connecting the connection portion 13B to the terminal portion 2B of the single cell in a state in which the extending portion 32 of the bus bar portion 12B is deformed to form an arch shape, the positional variations of the single cells can be absorbed without using the height as an absorbing structure. In particular, the height of the bus bar module 1B can be suppressed in comparison with a conventional bus bar branch strip (bus bar) which is folded in an S-shape in the vertical direction. By suppressing an increase in the height of the bus bar module 1B and reducing the height of the bus bar module 1B, it is possible to arrange the bus bar module 1B in a narrow space.

Further, each of the main body 11B and the bus bar portion 12B of the bus bar module 1B can be composed of a single-sided flexible substrate (single-sided substrate). Therefore, the manufacturing cost of the bus bar module 1B can be reduced compared with the case that the entire or a part of bus bar module 1B is composed of a double-sided flexible substrate (double-sided substrate).

Next, the effects of the bus bar module 1B will be described.

As described above, the bus bar module 1B according to the second embodiment includes a circuit body 4B composed of the flexible substrate provided with a circuit wiring (wiring 3B). The circuit body 4B includes a belt-shaped main body 11B extending along a predetermined direction and a plurality of bus bar portions 12B arranged at a distance in the extending direction X of the main body 11B. At least a part (extending portion 32) of the bus bar portions 12B is arranged to overlap with the main body 11B.

According to the bus bar module 1B, the positional variations of the single cells can be absorbed by the deformation of the extending portion 32 arranged to overlap with the main body 11B, and an increase in the height of the bus bar module 1B can be suppressed in comparison with the case that a bus bar portion 12B is folded in a S-shape in the vertical direction. Therefore, by reducing the height of the bus bar module 1B, it is possible to arrange the bus bar module 1B in a narrow space.

As described above, according to the second embodiment, while reducing the height of the bus bar module 1B, it is possible to provide the bus bar module 1B capable of absorbing positional variations of a counterpart connection device (single cell).

In the bus bar module 1B according to the second embodiment, a part of the bus bar portions 12B (extending portion 32) may be arranged to straddle the main body 11B in a direction intersecting the extending direction of the main body 11B.

By arranging the extending portion 32 of the bus bar portion 12B in this manner, it is possible to absorb the positional variations of the single cells in a direction intersecting (in the illustrated example, perpendicular to) the direction in which the single cells are aligned (the stacking direction of the single cells).

In the bus bar module 1B according to the second embodiment, the bus bar portion 12B may be formed separately from the main body 11B and may be thereafter electrically connected to the main body 11B.

Since the bus bar portion 12B is formed separately from the main body 11B, the circuit wiring of the bus bar portion 12B can be designed regardless of the design of the circuit wiring of the main body 11B.

Further, the bus bar portion 12B may have a circuit divider 31 electrically connected to the main body 11B, and an extending portion 32 extending from one end portion of the circuit divider 31 in the width direction Y of the main body 11B and extending to straddle from one end 11a side to the other end 11b side in the width direction Y of the main body 11B. The bus bar portion 12B may have a connection portion 13B connected to the extending portion 32 and connected to a terminal portion 2B of a counterpart connection device (single cell) arranged on the other end 11b side in the width direction Y of the main body 11B.

The extending portion 32 of the bus bar portion 12B straddles the main body 11B, so that the length in the direction of absorbing the positional variations of the single cells can be secured by the length of the extending portion 32, and a long distance can be secured to be able to absorb the positional variations in the alignment direction of the single cells.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

1. A bus bar module comprising:
a circuit body composed of a flexible substrate provided with a circuit wiring,
wherein the circuit body comprises a belt-shaped main body extending along a predetermined direction and a plurality of bus bar portions arranged at a distance in an extending direction of the main body,
wherein at least a part of the bus bar portions is arranged to overlap with the main body.

2. The bus bar module according to claim 1,
wherein the part of the bus bar portions is arranged to straddle the main body in a direction intersecting the extending direction of the main body.

3. The bus bar module according to claim 1,
wherein the bus bar portions have
a first extending portion extending from one end side in a width direction of the main body and extending in a direction away from the main body,
a folding portion connected to the first extending portion and folded in a direction toward the main body from a direction away from the main body,
a second extending portion connected to the folding portion and extending to straddle from one end side to the other end side in the width direction of the main body, and
a connection portion connected to the second extending portion and connected to a terminal portion of a counterpart connection device arranged on the other end side in the width direction of the main body.

4. The bus bar module according to claim 1,
wherein the bus bar portions are formed separately from the main body and is thereafter electrically connected to the main body.

5. The bus bar module according to claim 4,
wherein bus bar portions have
a circuit divider electrically connected to the main body,
an extending portion extending from one end portion of the circuit divider in the width direction of the main body and extending to straddle from one end side to the other end side in the width direction of the main body,
a connection portion connected to the extending portion and connected to a terminal portion of a counterpart connection device arranged on the other end side in the width direction of the main body.
